(19) United States
(12) Patent Application Publication
(10) Pub. No.: US 2010/0157161 A1
(43) Pub. Date: Jun. 24, 2010

(54) Gamma Correction Apparatus and Method

(76) Inventor: Kenichi Tanahashi, Ageo-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/640,804

(22) Filed: Dec. 17, 2009

(30) Foreign Application Priority Data
Dec. 24, 2008 (JP) 2008-328789

(51) Int. Cl. H04N 9/69

(52) U.S. Cl. 348/675; 348/728; 348/E09.054

(57) ABSTRACT

According to one embodiment, a gamma correction apparatus comprises a histogram module configured to acquire histograms of upper and lower portions of one frame which are obtained by dividing the frame into two by a given horizontal scanning line, and a correcting module configured to make gamma correction on a current frame based on the histogram of the upper portion of the current frame and the histogram of the lower portion of a preceding frame.

### CROSS-REFERENCE TO RELATED APPLICATIONS

This application is based upon and claims the benefit of priority from Japanese Patent Application No. 2008-328789, filed Dec. 24, 2008, the entire contents of which are incorporated herein by reference.

### BACKGROUND

1. Field

One embodiment of the invention relates to a gamma correction apparatus and method for a video display device, such as a color television (TV) receiver.

2. Description of the Related Art

A gamma correction apparatus has been developed which is adapted to make gamma correction based on a histogram representing a brightness distribution of an input video image (see paragraphs to [0024] and FIG. 1 in Jpn. Pat. Appln. KOKAI No. 2008-258925). In this brightness histogram, the graduation values of brightness are shown on the horizontal axis and the frequency of the number of pixels for each gradation is shown on the vertical axis. This gamma correction apparatus comprises a receive buffer, a histogram acquisition unit, a response improvement processing unit, a correction data generation unit, and a brightness characteristic correction (gamma correction) unit.

The receive buffer temporarily stores an input video signal which is a component signal input as video data comprising a brightness signal and color difference signals. The histogram acquisition unit acquires histogram data as a brightness distribution from the brightness signal in the video signal input from the receive buffer.

The response improvement processing unit uses histogram data from the histogram acquisition unit to control the transient response performance of actual gamma correction for video. Specifically, the processing unit calculates changes in the frequencies of past and current histogram data, then compares the past and current changes and imposes limitations on current gamma correction data over a wide limiting range based on the histogram data which is greater in the change of frequency, thereby improving the response to instantaneous changes such as scene changes. For subsequent scenes in which changes are gentle or no change occurs, the processing unit imposes limitations on gamma correction data over a narrow limiting range based on changes in histogram data multiplied by an attenuation gain, thereby obtaining stable gamma correction characteristics.

The correction data generation unit generates data for brightness correction (gamma correction data) based on the histogram data under control of the response improvement processing unit. The brightness characteristic correction (gamma correction) unit corrects the characteristics of the brightness signal (Y signal) in video data from the receive buffer through the use of the correction data from the correction data generation unit.

However, with such a gamma correction apparatus as makes gamma correction based on a histogram of each picture frame, the time taken to generate brightness correction data (gamma correction data) from histogram data results in a delay in real-time processing. For example, when histogram data are calculated during the period of each frame (first frame), it follows that gamma correction data are calculated during the period of the second frame and the video signal of two previous frames is output with gamma correction during the period of the third frame. For this reason, a video signal is output delayed by the time corresponding to two frames and moreover there is a need for a buffer memory which stores the video signal for the period corresponding to two frames.

In order to avoid these difficulties, one might suggest completing calculations of histogram data and gamma correction data within the period of each frame without calculating histogram data of the whole of each frame. That is, histogram data are calculated only for an upper portion of each frame and not calculated for a lower portion of each frame which corresponds to a time required to calculate gamma correction data. The gamma correction data are calculated based on the histogram data calculated for the upper portion within the period corresponding to the lower portion. Thereby, it is only required that the video signal be output delayed by the period of one frame and the buffer memory store the video signal for the period of one frame.

With this method, however, there is the possibility of inability to implement gamma corrections that accurately reflect histograms because the histogram of the lower portion is neglected. Thus, the conventional gamma correction apparatus has the possibility of inability to accurately reflect histograms if real-time performance is pursued.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of a TV control LSI circuit in a TV signal processing circuit to which the gamma correction apparatus according to the first embodiment of the present invention is applied;

FIG. 2 is an exemplary block diagram of the entire TV signal processing circuit;

FIG. 3A shows an exemplary video signal;

FIG. 3B shows an exemplary video signal;

FIG. 4A shows an exemplary histogram which corresponds to the video signal of FIG. 3A;

FIG. 4B shows an exemplary histogram which corresponds to the video signal of FIG. 3B;

FIGS. 5A, 5B, 5C, 5D, 5E and 5F exemplarily show the operating principle of the first embodiment;

FIG. 6 is an exemplary flowchart illustrating the operation of the first embodiment; and

FIG. 7 is an exemplary flowchart illustrating the operation of a modification.

### DETAILED DESCRIPTION

Various embodiments according to the invention will be described hereinafter with reference to the accompanying drawings. In general, according to one embodiment of the invention, a gamma correction apparatus comprises a histogram module configured to acquire histograms of upper and lower portions of one frame which are obtained by dividing the frame into two by a given horizontal scanning line; and a correcting module configured to make gamma correction on a current frame based on the histogram of the upper portion of the current frame and the histogram of the lower portion of a preceding frame.

### First Embodiment

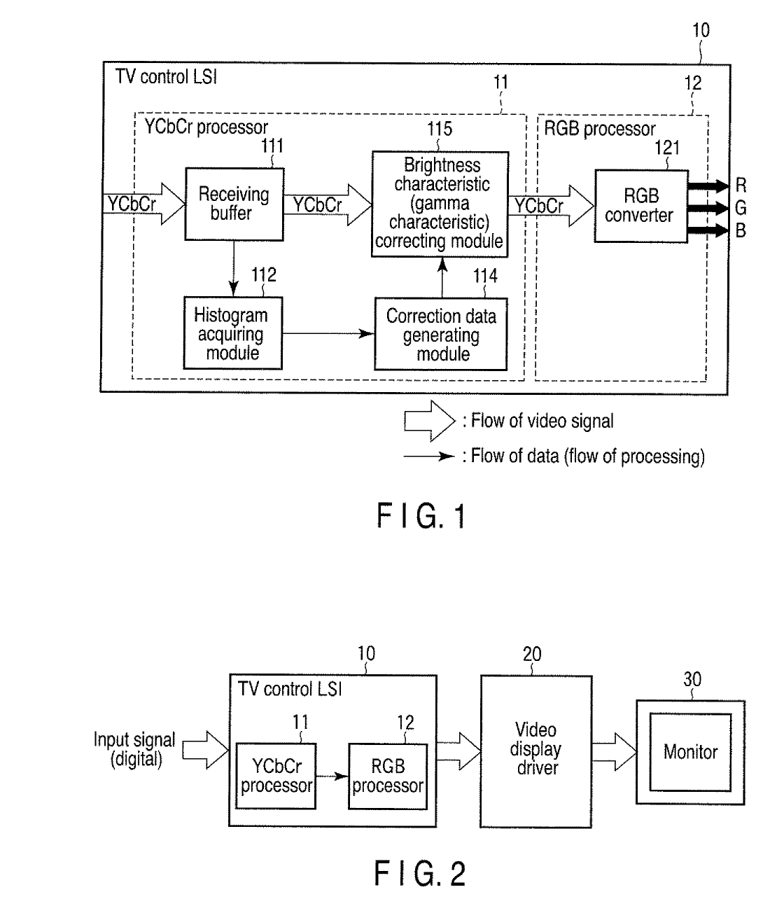

FIG. 1 is a block diagram of a TV control LSI circuit in a TV signal processing circuit to which the gamma correction apparatus according to the first embodiment of the present invention is applied. FIG. 2 is a block diagram of the entire TV signal processing circuit.

Reference is first made to FIG. 2 to describe the overall configuration of the TV signal processing circuit. The TV signal processing circuit of FIG. 2 comprises a TV control LSI circuit 10 containing the gamma correction apparatus, a video device driver 20, and a monitor 30. The TV control LSI circuit 10 is connected to the succeeding stage of a tuner not shown. The TV control LSI circuit 10, which is connected to receive a component signal (a brightness signal Y and color difference signals Cb and Cr), such as an MPEG-2, MPEG-4, or H.264 coded signal, as an input digital signal, includes a YCbCr processor 11 which performs YCbCr processing including brightness correction (gamma correction) and an RGB processor 12 which carries out RGB processing to convert gamma corrected YCbCr signals to RGB signals as three primary color signals. The gamma correction apparatus according to an embodiment of the present invention is contained in the TV LSI circuit 10.

The video device driver 20 receives RGB signals output from the TV control LSI circuit 10 and outputs RGB signals to the succeeding monitor 30. As the monitor 30 use may be made of a display device, such as a liquid crystal display (LCD), a plasma display panel (PDP), a cathode ray tube (CRT), or the like.

FIG. 1 shows the detail of the TV control LSI circuit 10. The TV control LSI circuit 10 comprises a YCbCr processor 11 having a gamma correction function for brightness correction (gamma correction) and an RGB processor 12 having an RGB converter 121 which makes YCbCr to RGB conversion. Here, YCbCr processor 11 is mainly configured to perform the gamma correction function and is therefore equivalent to a gamma correction apparatus.

The YCbCr processor 11 comprises a receive buffer 111, a histogram acquiring module 112, a correction data generating module 114, and a brightness characteristic (gamma characteristic) correcting module 115.

The receive buffer 111 is adapted to temporarily store YCbCr signals input as video data.

The histogram acquiring module 112 acquires histogram data as a distribution of brightness from the brightness signal (Y signal) in the YCbCr signals from the receive buffer 111.

The correction data generating module 114 generates brightness correction data (gamma correction data) from the histogram data output from the histogram acquiring module 112.

The brightness characteristic correcting module 115 corrects the characteristic of the brightness signal (Y signal) in the video data from the receive buffer 111 by using the correction data from the correction data generating module 114.

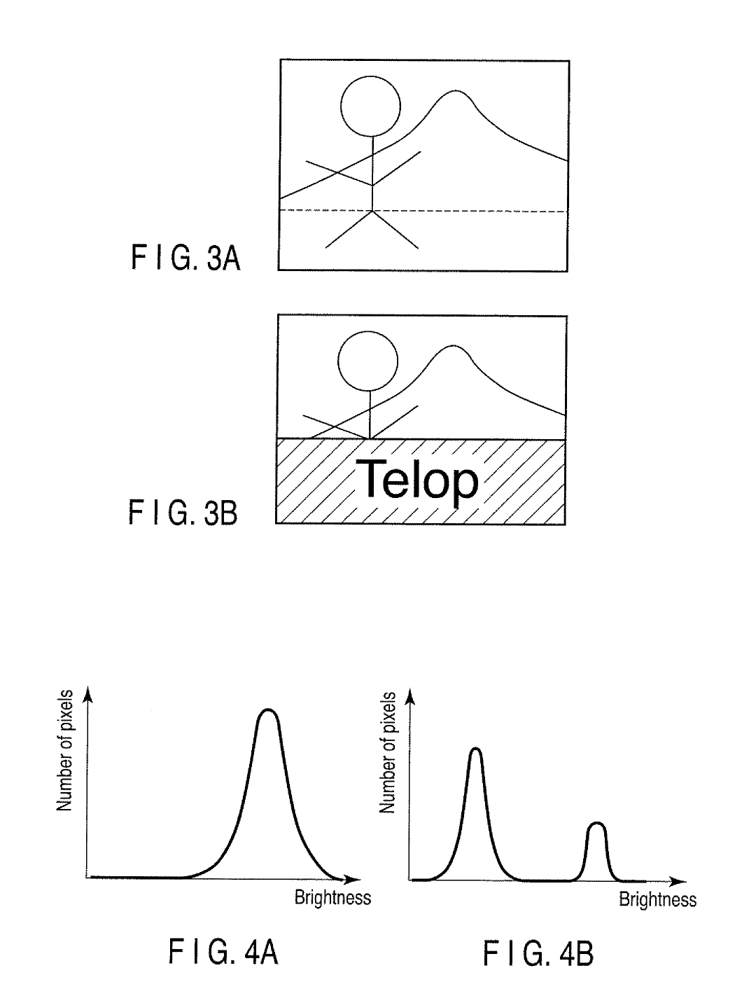

The operation of this embodiment will be described taking such video signals as shown in FIGS. 3A and 3B by way of example. It is assumed that the video signal contains pictures alone through the n-th frame and a subtitle appears in the lower portions of pictures from the (n+1)th frame. In the histogram of the n-th frame consisting of a picture, many pixels of high brightness are distributed as shown in FIG. 4A. In contrast, in the histogram of the (n+1)th frame in which the picture in its lower portion has been replaced by characters, the peak of the distribution of the pixels of high brightness is lowered and a distribution of pixels of low brightness also appears as shown in FIG. 4B. As described in the background, in order to complete calculations of a histogram and gamma correction data within the display period of each frame, if a histogram were not calculated for the lower portion (the portion lower than a certain horizontal scanning line) of a frame and gamma correction data were calculated based on the histogram for the upper portion of the frame during the period when the histogram for the lower portion of the frame is to be calculated, gamma correction would be made based on a wrong histogram. This would lead to inaccurate gamma correction. In many cases, character information, such as an subtitle, is superimposed on the lower portions of pictures; therefore, a histogram associated with the lower portion of each picture should not be ignored.

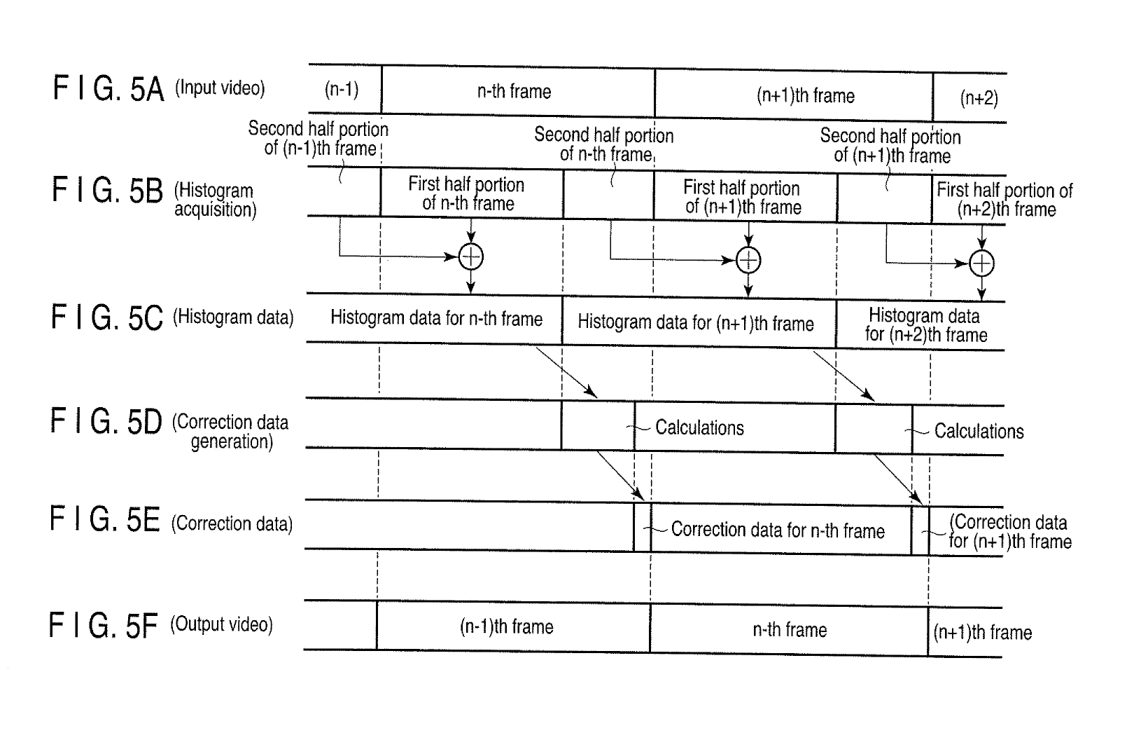

Reference is now made to FIGS. 5A to 5F to describe the principle of gamma correction according to this embodiment. The histogram acquiring module 112 divides a TV picture frame into the upper portion (the first-half portion) and the lower portion (the second-half portion) by a certain horizontal scanning line and acquires histograms for the upper and lower portions. The dividing position is set in such a way that gamma correction data can be generated from histogram data for the upper portion within the display period of the lower portion. FIG. 5A shows the frames of an input TV signal. FIG. 5B shows acquisition of a histogram in each of the first- and second-half portions of each frame. Each of the histograms thus acquired is held for at least one frame period. The histogram acquiring module 112 adds together the histogram of the first-half portion of the current frame and the histogram of the second-half portion of the preceding frame to generate histogram data for one frame. Upon termination of the first-half period of each frame, the correction data generating module 114 carries out operations to generate correction data from histogram data for one frame as shown in FIG. 5D. Since the dividing position on each picture is set to ensure that the operations are terminated within the second-half period of one frame, correction data can be obtained until a video signal of the next frame is input as shown in FIG. 5E. By setting this correction data in the brightness characteristic correcting module 115, the brightness characteristic (gamma characteristic) of each frame of video data output from the receive buffer 111 is corrected. The output video data from the brightness characteristic correcting module 115 is delayed by one frame period with respect to input video data (FIG. 5A) as shown in FIG. 5F.

Thus, gamma correction can be made based on the histogram of the entire picture by stopping the acquisition of the histogram halfway through one frame period and calculating correction data from the histogram data in the remaining period. In this case, a video signal is simply delayed by one frame period. For this reason, the delay of video data associated with gamma correction is allowed to be short and the receive buffer 111 simply holds video data for one frame period, thus allowing the need of a memory of large capacity to be eliminated.

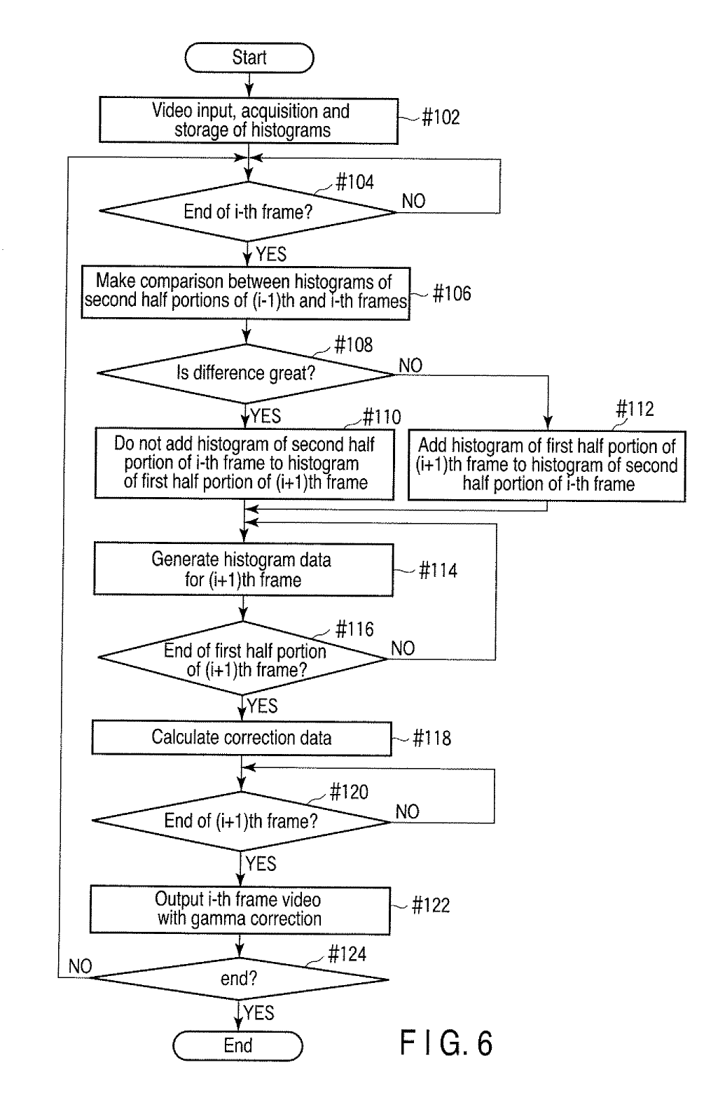

FIG. 6 is a flowchart illustrating a specific operation of the first embodiment. As shown in block #102, when the receive buffer 111 is supplied with a video signal, the histogram acquiring module 112 acquires histograms for the first- and second-half portions of each frame. The histograms thus acquired are each held for at least one frame period. When the end of a certain frame (i-th frame, where i is a positive integer) is detected in block #104, a comparison is made between the histograms of the second-half portions of the respective (I−1)th and i-th frames in block #106. If it is determined in block #108 that there is a great difference between the histograms (the difference is larger than a given value), then the procedure goes to block #110; otherwise, the procedure goes to block #112.

The principle of the gamma correction of this embodiment is based on the premise that there is no difference between the histograms of preceding and current frames (in particular, the histograms of the second-half portions of the frames). If, when the histogram of the second-half portion of the current frame is greatly differ from that of the preceding frame, gamma correction were made based on a histogram to which the histogram of the second-half portion of the preceding frame has been added, gamma correction data would change greatly, which could cause problems such as a luminance flicker. For this reason, when the decision in block #108 is that the difference between the histograms is small, to carry out such processing as shown in FIGS. 5A to 5F, the histogram of the first-half portion of the (i+1)th frame is added to the histogram of the second-half portion of the i-th frame in block #112. If, on the other hand, the decision in block #108 is that the difference between the histograms is large, the histogram of the second-half portion of the i-th frame is not added to the histogram of the first-half portion of the (i+1)th frame in block #110.

In block #114, the histogram data for the (i+1)th frame is generated based on the histogram of the (i+1)th frame obtained in block #110 or #112. When the change in histogram is small (the difference in histogram between preceding and current frames is small), the histogram data are generated by adding the histogram of the first-half portion of the (i+1)th frame and the histogram of the second-half portion of the i-th frame. When the change in histogram is large, the histogram data are generated based on the histogram of the first-half portion of the (i+1)th frame only.

When the end of the first-half portion of the (i+1)th frame is detected in block #116, the correction data generating module 114 calculates gamma correction data based on the histogram data for the (i+1)th frame in block #118. The correction data thus generated is set in the brightness characteristic correcting module 115.

When the end of the (i+1)th frame is detected in block #120, the brightness characteristic correcting module 115 corrects the brightness characteristic (gamma characteristic) of video data of the i-th frame in block #122.

In block #124, it is determined as to whether to terminate gamma correction or not. If not, the flow returns to block #104.

According to the first embodiment, as described above, each frame is divided into two by a given horizontal scanning line, and histograms of the first- and second-half portions of the frame are acquired. When the histogram of the second-half portion of the current frame does not greatly differ from that of the preceding frame, gamma correction data are calculated through the use of the histogram of the second-half portion of the preceding frame as the histogram of the second-half portion of the current frame. Thus, gamma correction can be made based on the histogram of the whole of one frame. If the current frame greatly differs from the preceding frame in the histogram of their second-half portion, gamma correction data are calculated based on only the histogram of the second-half portion of the current frame, thus preventing gamma correction from being made based on an incorrect histogram.

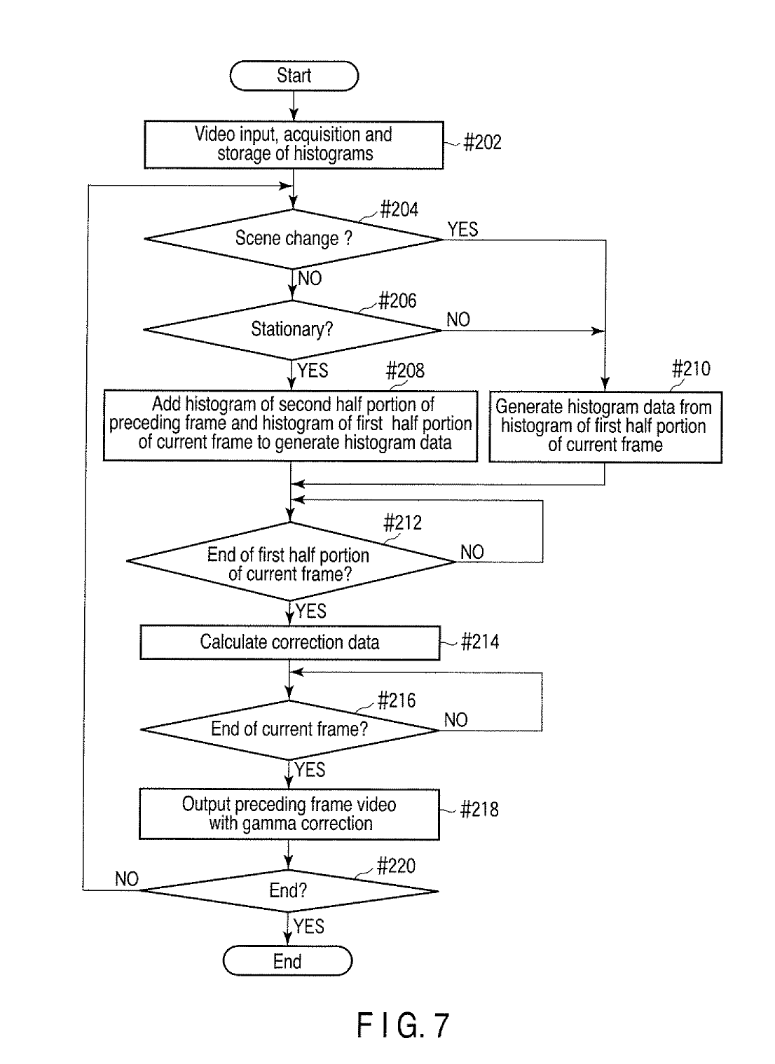

In the first embodiment, it is determined whether or not to consider the histogram of the second-half portion of the preceding frame based on the difference between the histograms of the second-half portions of the preceding and current frames; however, other detection method may be used. For example, in the field of television receivers, a function of detecting scene changes and a function of detecting the motion of a subject in pictures are known. In FIG. 7, there is illustrated an example of determining whether or not to consider the histogram of the second-half portion of the preceding frame using such detection method.

As shown in block #202, when a video signal is applied to the receive buffer 111, the histogram acquiring module 112 acquires a histogram of each of the first- and second-half portions of each frame. The histograms thus acquired are each held for at least one frame period. In block #204, it is determined whether or not a change in scene has been detected. If not, it is determined in block #206 whether or not a subject remains stationary. If the subject remains stationary, in order to carry out such processing as shown in

FIGS. 5A to 55, the histogram of the second-half portion of the preceding frame and the histogram of the first-half portion of the current frame are added together in block #208 to thereby generate histogram data for the current frame.

When a change in scene is detected in block #204 or when the decision in block #206 is that the subject does not remain stationary, histogram data for the current frame are generated in block #210 only from the histogram of the first-half portion of the current frame without adding the histogram of the second-half portion of the preceding frame to it.

When the end of the first-half portion of the current frame is detected in block #212, the correction data generating module 114 calculates, in block #214, gamma correction data from the histogram data obtained in block #208 or #210. The correction data thus generated are set in the brightness characteristic correcting module 115.

When the end of the current frame is detected in block #216, the brightness characteristic correcting module 115 corrects the brightness characteristic (gamma characteristic) of video data in the preceding frame output from the receive buffer 111 in block #218.

In block #220, it is determined as to whether to terminate gamma correction or not. If not, the flow returns to block #204.

Even with the example of FIG. 7, when the subject has little motion, gamma correction can be made based on the histogram of the whole of one frame. When the subject has much motion, no gamma correction will be made based on an incorrect histogram.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

Although the invention has been described in terms of an application to a television receiver, the principles of the invention are applicable to other video display devices, such as a DVD player, etc. The embodiments are configured to detect a change in subject for each frame and decide whether or not to add the histogram of the second-half portion of the preceding frame accordingly; however, in the case of a video in which the subject is known in advance to have very little motion, the histogram of the second-half portion of the preceding frame may be added all the time as shown in FIGS. 5A to 5F.

What is claimed is:

1. A gamma correction apparatus comprising:
a histogram module configured to acquire histograms of upper and lower portions of one frame which are obtained by dividing the frame into two by a given horizontal scanning line; and
a correcting module configured to make gamma correction on a current frame based on the histogram of the upper portion of the current frame and the histogram of the lower portion of a preceding frame.

2. The apparatus of claim 1, further comprising a detector configured to detect a difference between the preceding frame and the current frame, and wherein the correcting module is configured to make gamma correction on the current frame based on the histogram of the upper portion of the current frame when the detector detects the difference between the preceding and current frames.

3. The apparatus of claim 1, further comprising a detector to detect a difference between the preceding frame and the current frame, and wherein the correcting module is configured to make gamma correction on the current frame based on the histogram of the upper portion of the current frame and the histogram of the lower portion of the preceding frame when the detector detects no difference between the preceding and current frames.

4. The apparatus of claim 2, wherein the detector comprises a comparator configured to compare the histogram of the preceding frame with the histogram of the current frame.

5. The apparatus of claim 3, wherein the detector comprises a comparator configured to compare the histogram of the preceding frame with the histogram of the current frame.

6. The apparatus of claim 2, wherein the detector comprises a comparator configured to compare the histogram of the lower portion of the preceding frame with the histogram of the lower portion of the current frame.

7. The apparatus of claim 3, wherein the detector comprises a comparator configured to compare the histogram of the lower portion of the preceding frame with the histogram of the lower portion of the current frame.

8. The apparatus of claim 2, wherein the detector comprises a detector configured to detect a change in scene.

9. The apparatus of claim 3, wherein the detector comprises a detector configured to detect a change in scene.

10. The apparatus of claim 1, wherein a position of the given horizontal scanning line is in accordance with a processing time taken by the correcting module to make the gamma correction.

11. A television receiver comprising:
a tuner configured to select a video signal on a desired channel from broadcast signals;
a gamma correction apparatus connected to the output of the tuner; and
a display unit configured to display an output signal of the gamma correction apparatus, wherein the gamma correction apparatus comprises:
a histogram module configured to acquire histograms of upper and lower portions of one frame which are obtained by dividing the frame into two by a given horizontal scanning line; and
a correcting module configured to make gamma correction on a current frame based on the histogram of the upper portion of the current frame and the histogram of the lower portion of a preceding frame.

12. A gamma correction method comprising:
acquiring histograms of upper and lower portions of one frame which are obtained by dividing the frame into two by a given horizontal scanning line; and
making gamma correction on a current frame based on the histogram of the upper portion of the current frame and the histogram of the lower portion of the preceding frame.
